(19) United States
(12) Patent Application Publication
(10) Pub. No.: US 2004/0210853 A1
(43) Pub. Date: Oct. 21, 2004

(54) Method for dynamically distinguishing a character string

(76) Inventor: Craig J. Detter, Gurnee, IL (US)

Correspondence Address: MOTOROLA, INC., 1303 EAST ALGONQUIN ROAD, IL01/3RD, SCHAUMBURG, IL, 60196

(21) Appl. No.: 10/413,646

(22) Filed: Apr. 15, 2003

(51) Int. Cl. G09G 5/00

(52) U.S. Cl. 715/864; 345/619; 715/788

(57) ABSTRACT

A first signal is received to activate a first entry field (200). Upon receipt of the first signal, the first entry field is distinguished by at least one of the following attributes: changing a size of the first entry field, changing a font face of the first entry field, changing a color of the first entry field, and changing a property of the first entry field. The first entry is undistinguished when a second signal is received to de-activate the first entry field and to activate a second entry field, or when no activity has occurred within the entry field for an amount of time. Alternatively, a character string contained within an entry field at a position marked by a cursor is dynamically distinguished when the cursor is within or immediately adjacent to the character string.

### FIELD OF THE INVENTION

The present invention relates generally to a method for dynamically distinguishing a character string.

### BACKGROUND OF THE INVENTION

Eyestrain and readability are common problems with smaller computing devices, such as personal digital assistants (“PDAs”). These devices have smaller display screens, therefore making it a challenge to display a plurality of input fields simultaneously. Developers want to display, and users want to see, for example, an entire paper form on the display screen. Displaying an entire paper form may not always be possible due to lack of screen real estate. Newer portable devices, like PDAs, exacerbate this problem. That is, there is even less space available on the display screen, and the display screens are typically less crisp and less color accurate. Some PDAs even use monochromatic display screens, making reading the display screen more difficult. This in combination with various light or other environmental conditions make these display screens difficult to read for both data entry and editing.

A current solution to the above problem uses a magnifying glass technique to enlarge an area of the display screen to make the enlarged area easier to read. The floating magnifying glass technique is not an optimal solution as it simply enlarges everything in a given area of the display screen. That is, the magnifying glass technique is not discrete in making entry fields more readable. The magnifying glass technique indiscriminately enlarges a particular area, including field prompts and whatever else is in scope. Another disadvantage to the magnifying glass technique is that the magnifying glass distorts the surrounding area, making those areas more difficult to read, or unreadable all together. Moreover, the magnifying glass technique is typically manually controlled by the actions of the user; the user has to manually activate the magnifying glass function, disable the magnifying glass function, and move the magnifying glass around the display screen, etc. each time the user wants to indicate the area magnification or use the function.

Other solutions include simply making all the fields statically larger or bolder on the display screen. This solution makes the problem worse as larger fields makes even less room available for other information to be visible to the user on the display screen.

Moreover, the user can sometime have tunnel vision when using the PDA; the user is required to focus so intently on the entry or edit, he loses his peripheral vision. Tunnel vision can cause eyestrain, and can also be dangerous for public safety officers in that they need peripheral vision to identify individuals or behaviors that could put them at risk.

Thus, there exists a need for a method for dynamically distinguishing an entry field and/or a character string on behalf of the user while retaining readability of a majority of the surrounding entry fields.

### BRIEF DESCRIPTION OF THE FIGURES

A preferred embodiment of the invention is now described, by way of example only, with reference to the accompanying figures in which:

FIG. 1 illustrates a structural block diagram of an input device in accordance with the preferred embodiment of the present invention;

FIG. 2 illustrates a screen shot of an electronic form in accordance with a first example of the present invention;

FIG. 3 illustrates a screen shot of FIG. 2 after a timeout period has elapsed in accordance with the first example of the present invention; and

FIG. 4 illustrates a screen shot of paragraphs of text in accordance with a second example of the present invention.

### DETAILED DESCRIPTION OF THE PREFERRED EMBODIMENT

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

The present invention dynamically distinguishes the entry field temporarily, on behalf of the user, as data entry and/or editing is being performed; the present invention uses the term “dynamically” to mean during the time of operation of the software by the end user. The present invention further distinguishes at least the current character string, on behalf of the user, in which the cursor is within or immediately adjacent to. The present invention also dynamically undistinguishes the entry field after, on behalf of the user, after a timeout period has lapsed or when the entry field is no longer active (i.e., in focus); the present invention dynamically undistinguishes the character string, on behalf of the user, after a timeout period has lapsed or when the cursor is no longer within or immediately adjacent to the character string. Thus, the present invention allows the user to use a small input device while easily viewing the character strings during data entry/editing by dynamically distinguishing the entry field and/or the character string itself on behalf of the user. Further, the present invention reduces tunnel vision and eyestrain that may occur with a small input device while retaining readability of a majority of the surrounding entry fields.

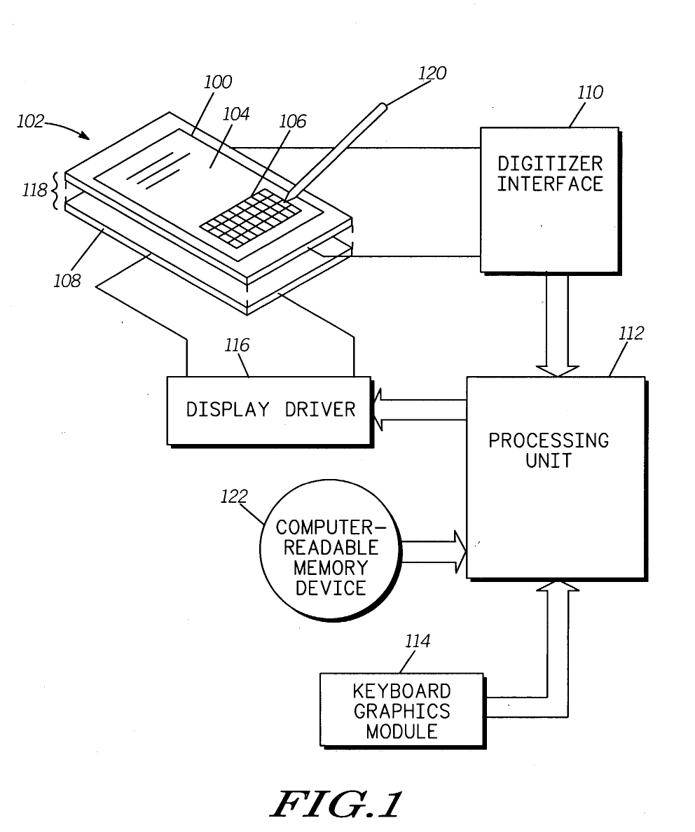

Let us first discuss the structure of the input device according to the preferred embodiment of the present invention. As illustrated in FIG. 1, a graphical display screen 100 of the input device 102 enables the display of a graphical user interface (“GUI”) 104 and keyboard 106. It should be noted that the keyboard 106 might comprise any type of characters (e.g., letters, numbers, special characters, etc.) and/or display any type of configuration thereof (e.g., the characters displayed in a particular order such as in a QWERTY keyboard).

In the preferred embodiment, the internal circuitry of the input device 102 comprises a touch sensitive surface 108, an input interface 110, a processing unit 112, a keyboard graphic module 114, and a display driver 116. The touch sensitive surface 108 and the graphical display screen 100 create a touch screen 118. Preferably, the touch sensitive surface 108 is a resistive grid, but could alternatively be an inductive grid, capacitance grid or any other touch sensitive surface known in the art.

The input interface 110 is coupled to the touch sensitive surface 108. The input interface 110 translates pressure on the touch sensitive surface into Cartesian coordinates (hereinafter referred to as “coordinates”) and transmits the coordinates to the processing unit 112. The coordinates identify the current location of a stylus 120 used to enter and/or edit data. Thus, as the stylus 120 exerts pressure on the touch screen 118 by moving across the GUI 104 and/or the keyboard 106, the input interface 110 generates new coordinates in order to keep current of the location of the stylus 120 as typically known to those individuals skilled in the art.

The processing unit 112 is coupled to the input interface 110. Upon receiving the coordinates from the input interface 110, the processing unit 112 is programmed by a computer-readable storage (memory) device 122 having instructions and data stored therein which, when loaded into the processing unit 112, causes the processing unit 112, to perform the functions of the present invention, particularly, a) dynamically distinguish an entry field and associated character string(s) upon gaining “focus”; b) dynamically undistinguish the entry field and associated character string(s) upon losing “focus”; c) dynamically undistinguish the entry field and associated character string(s) after an amount of time (timeout period) has lapsed; d) dynamically distinguish a character string in which the cursor is within or immediately adjacent to, particularly from, but not limited to the surrounding text; e) dynamically undistinguish the character string after an amount of time (timeout period) has lapsed; and/or f) dynamically undistinguish the character string when the cursor is no longer within or immediately adjacent to the character string. For purposes of the present invention, an entry field gains “focus” when the entry field becomes active (i.e., when the cursor enters the entry field for data entry/edit). An entry field loses “focus” when the entry field is no longer active (i.e., when the cursor leaves the entry field).

The keyboard graphics module 114 is coupled to the processing unit 112. The keyboard graphics module 114 communicates to the processing unit 112 the type of characters associated with the keyboard 106 (e.g., special characters, selected characters, etc.) and/or their configuration displayed on the GUI 104 as known to those individuals skilled in the art.

The display driver 116 couples the processing unit 112 to the graphical display screen 100. The output from the processing unit 112 is transmitted to the display driver 116 that turns on or off pixels within the GUI 104 as known to those individuals skilled in the art.

At this point, the preferred hardware and software components implementing the present invention have been described. It will be obvious to those skilled in the art that all the hardware and/or software components described above may not be needed to implement the present invention. It will also be obvious to those skilled in the art that alternative hardware and/or software components than those described above may be used to implement the present invention. Let us now turn the discussion to specific examples of the present invention. It is important to note that the following examples are used for exemplary purposes only, and are not intended to limit the spirit and scope of the present invention in any manner.

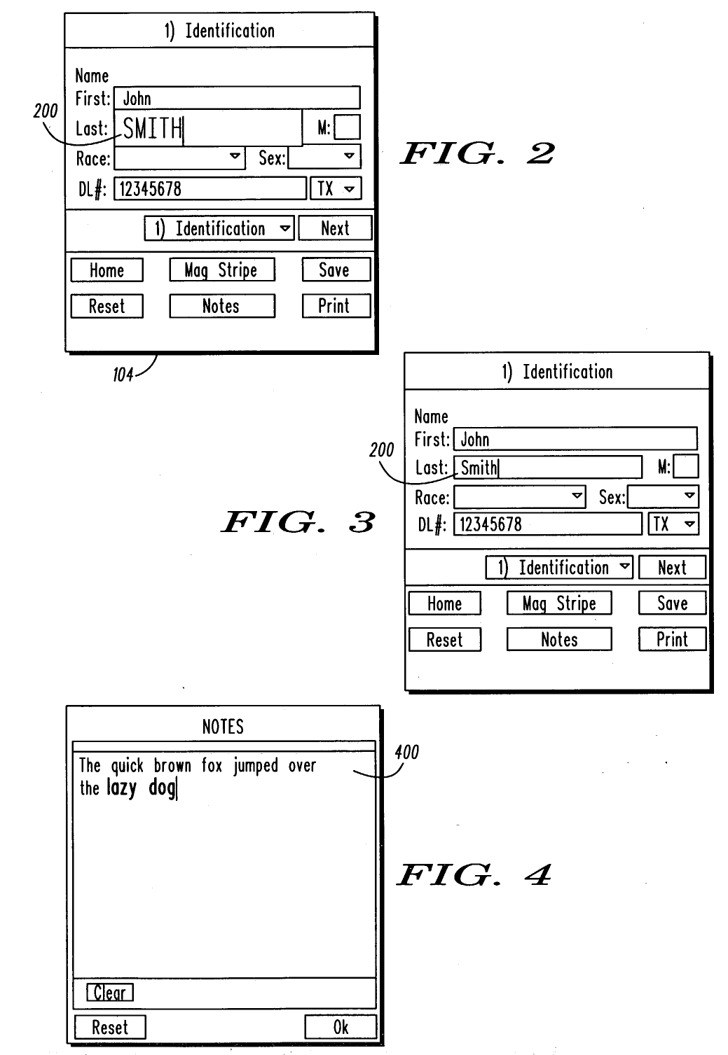

The first example of the present invention describes data entry/editing into a plurality of edit boxes on an electronic form. An edit box is a type of entry field; the term edit box is defined as an area designed for text input by the end user. As illustrated in FIG. 2, the present invention dynamically distinguishes the edit box 200, and associated character string, currently “in focus”; in the present invention, the edit box 200 becomes “focused” by selecting it with the stylus 120, using a tab function, or the like. In this specific example, the “last name” edit box 200 gained focus as the user selected the field containing the last name field value of “SMITH”.

In this example, the present invention distinguishes the focused edit box 200 and associated character string by enlarging the size of the edit box 200 and associated character string from their default values. It is important to note that the present invention temporarily enlarges only the active edit box 200 and associated character string, rather than a given area of the screen as described in the background. The expansion size of the edit box 200/character string may be statically defined, such as a twenty percent enlargement; alternatively, the expansion size of the focused edit box 200/character string may be user-definable. It should be noted that in the preferred embodiment, the focused edit box 200 enlarges “in place”; i.e., the focused edit box 200 expanded from it current horizontal center position (placement), however, expanding from its current center position is not necessary. The advantage of enlarging the focused edit box 200 “in place” allows the user to view the majority, if not all, of the edit boxes displayed at any given time while performing data entry/edit.

It is important to note that the present invention may have alternatively distinguished the edit box 200 and associated character string(s) currently in focus by at least one of the following attributes: changing the size of the edit box/character string, changing the font face of the edit box/character string, changing the color of the edit box/character string, changing a property of the edit box 200/character string (e.g., bolded, italicized, underlined, shadowed, highlighted, etc.), etc; it should be obvious to those individuals skilled in the art that the edit box/character string may be distinguished in a variety of other ways, and should not be considered limited to those listed above. Dynamically distinguishing the focused edit box 200 and/or associated character string allows the focused edit box 200/character string to become easily readable as data entry and/or editing is being performed. Thus, the present invention has the advantage of allowing the user to quickly view at-a-glance which edit box is currently in focus, without the need to locate the cursor.

Preferably, if data entry and/or editing subsides for an amount of time (i.e., a timeout period) while the cursor remains in the focused edit box (i.e., the edit box is still active), the focused edit box 200 reduces to the size of its default value as illustrated in FIG. 3; in the preferred embodiment, the focused edit box 200 expands in size if activity (e.g., data entry, data editing, etc.) resumes within the focused edit box 200. Additionally, an edit box returns to its default value when it “loses focus” (i.e., when the cursor leaves the edit box; e.g., when the user inputs/edits data in a different edit box). Once the edit box “loses focus”, the edit box returns to its default value immediately or after a predetermined amount of time.

Let us now discuss the second example of the present invention: data entry/editing of paragraphs of text/character strings. In the preferred embodiment, as illustrated in FIG. 4, character strings are typed and displayed in a multi-line edit box 400. The present invention dynamically “distinguishes” at least the character string in which the cursor is within or immediately adjacent to. The present invention can also be extended to dynamically “distinguish” at least one additional character string that has been entered within a predefined period of time. In this particular example, two character strings (i.e., “lazy” and “dog”) are made “distinguishable” from the other character strings in the multi-line edit box 400.

Preferably, after a predetermined amount of time lapses after the character string has been entered/edited, or alternatively, after a punctuation mark or break in the character string indicating the completion of the character string (as a result of a space, carriage return, or the like), the character string becomes “undistinguishable” from the other character string(s) displayed in the multi-line edit box 400. Again, making the character string undistinguishable can occur immediately or after a predetermined amount of time has lapsed.

It should be noted that a character string may be “distinguishable” from the other character string(s) in the multi-line edit box 400 in a variety of ways that will be obvious to those skilled in the art; for example, the character string(s) may be displayed in a different font size, different font face, different color, different property (e.g., bolded, italicized, underlined, shadowed, highlighted, etc.), or the like. In this example, the character strings (i.e., “lazy” and “dog”) are “distinguished” from the other character strings in the multi-line edit box 400 by temporarily taking on a larger font size and a bolder font face. Thus, as in the first example, the user easily views what s/he recently entered/edited.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

I claim:

1. A method comprising the steps of:
receiving a first signal to activate a first entry field;
upon receipt of the first signal, distinguishing the first entry field by at least one of the following attributes: changing a size of the first entry field, changing a font face of the first entry field, changing a color of the first entry field, and changing a property of the first entry field;
receiving a second signal to de-activate the first entry field and to activate a second entry field; and
upon receipt of the second signal, undistinguishing the first entry field and distinguishing the second entry field by at least one of the following attributes: changing a size of the second entry field, changing a font face of the second entry field, changing a color of the second entry field, and changing a property of the second entry field.

2. The method of claim 1 wherein the at least one of the first entry field and the second entry field is an edit box.

3. The method of claim 1 wherein the first entry field and the second entry field are co-located on an electronic form.

4. The method of claim 1 wherein at least one of the first entry field and the second entry field is distinguished by setting the at least one attribute to a predefined value.

5. The method of claim 1 wherein at least one of the first entry field and the second entry field is distinguished by setting the at least one attribute to a user-defined value.

6. The method of claim 1 wherein at least one of the steps of receiving a first signal, distinguishing the first entry field, receiving a second signal, undistinguishing the first entry field, and distinguishing the second entry field is stored in a storage medium, which when the storage medium is loaded into a hardware device, causes the hardware device to perform the at least one step.

7. A method comprising the steps of:
receiving a signal to activate an entry field;
upon receipt of the signal, distinguishing the entry field by at least one of the following attributes: changing a size of the entry field, changing a font face of the entry field, changing a color of the entry field, and changing a property of the entry field;
undistinguishing the entry field if no activity has occurred within the entry field for an amount of time; and
distinguishing the first entry field by at least one of the attributes when activity resumes within the entry field.

8. The method of claim 7 wherein the entry field is an edit box.

9. The method of claim 7 wherein the entry field is distinguished by setting the at least one attribute to a predefined value.

10. The method of claim 7 wherein the entry field is distinguished by setting the at least one attribute to a user-defined value.

11. The method of claim 7 wherein at least one of the steps of receiving a signal, distinguishing, and undistinguishing is stored in a storage medium, which when the storage medium is loaded into a hardware device, causes the hardware device to perform the at least one step.

12. A method comprising the steps of:
identifying a character string contained within an entry field at a position marked by a cursor; and
dynamically distinguishing the character string in the entry field when the cursor is within or immediately adjacent to the character string.

13. The method of claim 12 further comprising the step of reducing the size of the character string when the cursor is no longer within or immediately adjacent to the character string.

14. The method of claim 12 further comprising the step of reducing the size of the character string after a predefined period of time.

15. The method of claim 12 further comprising the step of reducing the size of the character string when a break in the character string occurs.

16. The method of claim 12 further comprising the step of reducing the size of the character string after a punctuation mark immediately follows the character string.

17. The method of claim 12 wherein the step of dynamically distinguishing the character string comprises at least one of the following: enlarging a font size of the character string, changing a font face of the character string, changing a property of the character string, and changing a color of the character string.

18. The method of claim 12 wherein the step of dynamically distinguishing a character string is user-selected.

19. The method of claim 12 wherein at least one of the steps of identifying a character string and dynamically distinguishing the character string is stored in a storage medium, which when the storage medium is loaded into a hardware device, causes the hardware device to perform the at least one step.

20. The method of claim 12 wherein the entry field is an edit box.
